(19) United States
(12) Patent Application Publication
(10) Pub. No.: US 2026/0233310 A1
(43) Pub. Date: Aug. 13, 2026

(54) METHODS OF CRACK MITIGATION FOR HIGH-STRENGTH ALUMINUM ALLOYS MADE BY ADDITIVE MANUFACTURING AND HIGH-STRENTH ALUMINUM ALLOYS MADE THEREFROM

(71) Applicant: Purdue Research Foundation, West Lafayette, IN (US)

(72) Inventors: Xinghang Zhang, West Lafayette, IN (US); Haiyan Wang, West Lafayette, IN (US); Benjamin Thomas Stegman, Seatle, WA (US); Anyu Shang, West Lafayette, IN (US)

(73) Assignee: Purdue Research Foundation, West Lafayette, IN (US)

(21) Appl. No.: 18/986,894

(22) Filed: Dec. 19, 2024

Related U.S. Application Data
(60) Provisional application No. 63/612,492, filed on Dec. 20, 2023.

(51) Int. Cl. B22F 10/47; B22F 10/28; B33Y 10/00; C22C 21/00

(52) U.S. Cl. CPC B22F 10/47; B22F 10/28; B33Y 10/00; C22C 21/00; B22F 2301/052; B22F 2998/10; B22F 2999/00

(57) ABSTRACT

A method of mitigating crack formation in an article produced by additive manufacturing process is disclosed. The method utilizes Selective laser melting (SLM). The method contains the steps of utilizing a selective leaser melting (SLM) apparatus to produce a first layer of particles of a selected material on a substrate and melting and solidifying a first group of selected areas of the first layer of particles, wherein the melting and the solidification results in a pre-determined structure of the selected material; repeating utilization of SLM apparatus to produce second and subsequent layers as needed to produce layers of desired configurations to result in a predetermined scaffolding structure; and utilizing a selective leaser melting (SLM) apparatus to produce an article of specified thickness and shape on top of and in contact with the scaffolding structure. An article made by the method of this disclosure is described.

### CROSS-REFERENCE TO RELATED APPLICATIONS

The present U.S. patent application is related to and claims the priority benefit of U.S. Provisional Patent Application Ser. No. 63/612,492, filed Dec. 20, 2023, the contents of which hereby incorporated by reference in their entirety into the present disclosure.

### STATEMENT REGARDING GOVERNMENT FUNDING

This invention was made with government support under DMR 2210152 awarded by the National Science Foundation, under N00014-17-1-2921 and N00014-20-1-2043 awarded by Office of Naval Research. The government has certain rights in the invention.

### TECHNICAL FIELD

The present disclosure generally relates to fabrication methods for certain high-strength aluminum alloys made by additive manufacturing, especially to reduce or eliminate crack creation and propagation during and after the fabrication process.

### BACKGROUND

This section introduces aspects that may help facilitate a better understanding of the disclosure. Accordingly, these statements are to be read in this light and are not to be understood as admissions about what is or is not prior art.

Laser powder bed fusion (LPBF), also known as selective laser melting (SLM), is an additive manufacturing technique applicable to metallic parts (ASTM). Aluminum (Al) alloys find wide applications in marine, automotive, and aerospace industries for their low density, high specific strength, excellent corrosion resistance, and high thermal and electrical conductivities. Though LPBF has been widely used to print a variety of Al alloys, many high-strength Al alloys, e.g., AA 6061 and AA 7075, suffer from limited printability. Multiple defects have been identified in the as-printed state, including porosity, hot cracks, anisotropy, and poor surface quality. Among these types of defects, cracks are usually the most serious and detrimental to mechanical properties.

Extensive efforts have been made to develop and commercialize 3D-printable high-strength Al alloys. On the one hand, Al—Si alloys with near eutectic compositions, namely AlSi10Mg and Al-12Si are prominent examples of crack-resistant alloy compositions. Their versatility and reliability in printing stem from a low solidification temperature range bounded by solidus and liquidus lines. As a result, it has been found that the optimization of printing parameters is sufficient to diminish or eliminate pores and cracks in near-eutectic Al—Si. Post-heat treatment and second phase addition could further diminish defects or tune the mechanical performance. However, the overall strengths of these alloys are significantly lower than the high-strength alloys commonly used in structural components.

On the other hand, attempts were made to modify the chemistry to achieve printability in high-strength Al alloy. Cracking in the non-weldable high-strength Al alloys is typically attributed to two mechanisms: liquation cracking and solidification cracking. Solidification cracking refers to intergranular cracking in the fusion zone during the solidification of the weld metal, whereas liquation cracking denotes cracking due to liquated base metal in the partially melted zone. For Al alloys enriched with solutes, like Zn, Cu, Mg, both cracking mechanisms co-exist and could be interfered or mutually triggered due to the cyclic thermal history. Among these two mechanisms, solidification cracking seems more prevailing pondering from the crack length and fractography. Solidification cracking is associated with the existence of inter-granular liquid films. As solidification initiates and progresses, solute atoms in Al alloys are continuously rejected and expelled into liquid ahead of the solidification front. This microsegregation at solid-liquid interface accumulates and induces constitutional supercooling, leading to cellular or dendritic growth. Near the terminal stage of solidification, thin liquidous films with excessive alloying elements and a low melting point are present between columns or dendrites. Accompanied by the tensile stress developed in the inter-dendritic region due to thermal shrinkage (~6 to 8 volume percent) of neighboring grains and density difference from the melt, liquid films provide easy pathways for delamination on the mushy zone and resultant so-called solidification cracks. This is exacerbated by a short lifetime (around 20 ms) of liquid backfill due to the steep thermal gradient (104 to 106 K/s) rendered by laser heating and high thermal conductivity. Therefore, sensitivity to solidification cracking is related to a prolonged solidification temperature range and an abundance of soluble elements. A criterion was proposed to quantify hot cracking susceptibility: |dT/d(fs_{1/2})| near fs^{1/2}=1, where T is the temperature and fs is the fraction of the solid in the semisolid. This model incorporates the lateral growth rate of columnar grains and length of intergranular channel for liquid backfill. A higher value implies a greater cracking tendency. With the assistance of quantitative criteria, cracking susceptibility could be depressed by fine tuning the concentration of alloying elements. This model has been successfully validated in several systems both in the context of welding and additively manufactured Al—Cu, Al—Si systems, and provides physical insights on chemistry determination.

Another strategy is to incorporate nucleation agents to promote equiaxial grain growth. Inoculated with ceramic nanoparticles like TiC, TiB₂, or intermetallic forming elements, like Ti, Zr, Sc, Ce, heterogeneous nucleation is encouraged on the lattice-matched nucleant-Al interface on the onset of solidification. It is noticeable that the shapes of solidification curves are not substantially altered for the final stage, which would indicate little change in cracking susceptibility criterion. Instead, the high cracking resistance stems from the refined grain size and the equiaxial grain morphology that can better accommodate the solidification contraction than coarse and columnar grains, despite an unfavorable solidification ending.

Extrinsic approaches are also adopted to mitigate cracking, in contrast to intrinsic changes to chemistry or nucleation. Adjusting laser power, scanning speed, and defocus length could diminish cracks by changing the melt fluid dynamics from conduction mode with epitaxial-like grains to keyhole mode with refined and less textured grains, yet it is difficult to eliminate cracks. Pre-heating on the build plate also decreases crack density by attenuating thermal shock and extending periods of liquid backfill due to the retarded thermal dissipation. Crack curing effect starts to be perceivable at least above 200° C. but preheating solely could not suppress cracking even up to 500° C. Heat retention by a thermal insulating build plate adopts a similar idea by preventing rapid cooling. Notable crack mitigation is also achieved with other methods including: manipulation of scanning strategies, overlap rate of adjacent laser tracks, specimen geometry, and hot isostatic pressing (HIPing).

Through existing strategies, identification of optimal processing parameters for defects-free high-strength Al alloys is challenging. To take advantage of high-performance alloy compositions, crack suppression strategies must be developed to determine their effectiveness and identify generalizable methods which address the most significant cracking mechanisms.

Due to the factors mentioned above, a need exists for developing crack mitigation methods and strategies in fabricating high-strength aluminum alloys.

### SUMMARY

A method A method of mitigating crack formation in an article produced by additive manufacturing process is disclosed. The method utilizes Selective laser melting (SLM). The method contains the steps of utilizing a selective leaser melting (SLM) apparatus to produce a first layer of particles of a selected material on a substrate and melting and solidifying a first group of selected areas of the first layer of particles, wherein the melting and the solidification results in a pre-determined structure of the selected material; repeating utilization of SLM apparatus to produce second and subsequent layers as needed to produce layers of desired configurations to result in a predetermined scaffolding structure; and utilizing a selective leaser melting (SLM) apparatus to produce an article of specified thickness and shape on top of and in contact with the scaffolding structure. An article made by the method of this disclosure is described.

### BRIEF DESCRIPTION OF DRAWINGS

While some of the figures shown herein may have been generated from scaled drawings or from photographs that are scalable, it is understood that such relative scaling within a figure are by way of example, and are not to be construed as limiting.

FIG. 1A shows cross-section morphology of the gas atomized Al₉₂Ti₂Fe₂Co₂Ni₂ alloy powders. The insert shows two forms of intermetallic compounds, acicular-Al₃Ti and globular-Al₉(Fe,Co,Ni)₂ in Al matrix.

FIG. 1B shows particle size distribution of Al₉₂Ti₂Fe₂Co₂Ni₂ powders.

FIG. 2A shows single laser tracks indicating three regions of melt pool dynamics: balling/unstable, conduction and keyhole region.

FIG. 2B shows top-down views showing the morphologies and widths of the representative laser tracks for each region of FIG. 2A (Balling: 250 W, 2000 mm/s; Conduction: 250 W, 1200 mm/s; Keyhole: 350 W, 800 mm/s. The arrows indicate the discontinuous beads which do not form as a regular track.)

FIG. 3 shows a panoramic view of optical microscopy images for the bottom surface of samples printed with various laser power and scanning speed. The lower left corner represents a high volumetric energy density (VED).

FIG. 4 shows statistics on evolution of porosity and crack density with VED. Crack density monotonically decreases with increasing VED, but cracks cannot be fully eliminated within the investigated range. Porosity reaches a valley at around 60 J/mm³.

FIG. 5 shows Vickers hardness evolution of the as-printed samples with respect to laser power and scanning speed. Parts printed with all the parameter sets show a high hardness ranging from 160 HV to 250 HV. Hardness is inversely related to the VED value.

FIG. 6A shows an optical image of the sample printed with 250 W laser power and 1200 mm/s scanning speed.

FIGS. 6B and 6C show optical microscopy image corresponding to FIG. 6A on the polished side surface and bottom surface respectively showing cracks (indicated by arrow heads) and pores (indicated by dotted circles).

FIG. 6D shows a backscattered SEM micrograph showing the crack propagated across multiple melt pool boundaries (shown by dashed lines).

FIG. 6E shows an SEM image for the crack near the melt pool boundary with some fractured rosettes.

FIG. 6F shows a relatively wide crack is terminated with traces of microcracks resembling the delta pattern at the end of rivers.

FIG. 6G shows an image showing the magnified view of the cracks with “cups and cones” morphology.

FIGS. 7A and 7B show an optical microscopy image collection for the bottom surface and the side surface respectively of samples printed with three selective VEDs and varying secondary laser processing parameters: “V50”, P=300 W, v=2000 mm/s, VED=50 J/mm³; “V69”, P=250 W, v=1200 mm/s, VED=69 J/mm³; “V83”, P=100 W, v=400 mm/s, VED=100 J/mm³; “SL=10”, 10 mm laser strip length; “SL=15”, 15 mm laser strip length; “Chessboard”, chessboard scanning pattern. Specimens were fabricated by varying the default parameters one at a time so as to study individual parameters' effects on defect density.

FIG. 8 shows statistics of crack density in specimens fabricated with the three selected VEDs and varying secondary parameters in FIGS. 7A and 7B. VED=50 J/mm³ (a); (b) VED=69 J/mm³ (b); VED=83 J/mm³ (c); crack density on bottom surface on side surface. Are indicated. Horizontal dashed lines are drawn for easy visualization of crack density change in reference to the original printing strategy. NC—No contour. All other specimens were printed with contours. The box in (b) highlighted that “no contour” appears to be the most effective strategy for mitigating cracking.

FIG. 9A shows an optical image of the bottom surface of the specimen printed without laser path rotation every layer. The insert shows the bi-directional scanning tracks.

FIG. 9B shows an SEM micrograph for the crack.

FIGS. 9C and 9E show analyses based on sin² χ-d method reveal residual stress components in transversal direction.

FIGS. 9D and 9F show analyses based on sin² χ-d method reveal residual stress components in longitudinal direction.

FIG. 10A shows a schematic on the support structure design resembling “waffle islands”. Each “island” is 1.5× 1.5 mm (red square), 0.2 mm apart, composed of crisscross platelets. Four “islands” form a unit, and units are spaced by 0.2 mm. The lower right insert shows its projection along the building direction.

FIG. 10B shows an optical image on the specimen printed with the support structure. The open vertical cavities (shown by pink arrows) are where inter-island channels intersect with the surface. A visible curvature pattern is witnessed for “waffles” in a periodic manner (insert).

FIG. 10C shows an overlook of specimens of various geometries successfully printed on the support structure.

FIGS. 11A, 11B and 11C show Cross-sectional XCT image showing cracks in sample without support, XCT back-forward view showing abundant continuous cracks and XCT bottom-up projection view showing abundant continuous cracks, respectively, all in sample without support.

FIGS. 11D and 11E show Cross-sectional XCT image Back-forward projection view respectively showing crack free region in samples with support.

FIG. 11F shows XCT bottom-up view showing cracks initiated from support/built plate interfaces. Inserts on the upper right corner of each figure demonstrate the field of view with a red rectangle in relation to the whole specimen geometry.

FIG. 12A shows vertical cross-section of the specimen printed on the support structure.

FIGS. 12 D, 12E and 12 F show horizontal sections in the building direction with the corresponding heights corresponding to those denoted in FIG. 12A.

FIGS. 12 B, 12C, 12D shows observed at different planes ins samples with support within support.

FIG. 12 E shows significant diminishing of cracks at the interface between the support and the part,

FIG. 12F shows crack-free solid building material.

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended, such alterations and further modifications in the illustrated device, and such further applications of the principles of the disclosure as illustrated therein being contemplated as would normally occur to one skilled in the art to which the disclosure relates.

Laser powder bed fusion is capable of fabricating aluminum (Al) alloy parts with great geometrical flexibility and rapid prototyping for various industries. However, high strength Al alloys generally suffer from solidification cracks due to the steep thermal gradient associated with the laser fusion process. In this disclosure are described strategies to mitigate the hot crack susceptibility of a high strength Al₉₂Ti₂Fe₂Co₂Ni₂ alloy. Routine processing parameter optimization based on varying laser power and scanning speed has to trade off porosity for producing crack-free parts, making it not suitable for load-bearing structural applications. Furthermore, secondary printing parameters, including laser strip length, laser defocus, scanning strategies, etc., improved printability but were insufficient to eliminate all the cracks. Crack morphology and residual stress measurements indicate that the cracks are generated in the solid state driven by large tensile residual stress, instead of solidification cracking or liquation cracking. Thus, an attempt was made to alleviate the residual stress in a controlled manner. By properly introducing a compliant, sacrificial, scaffold support structure to regulate crack propagation, near fully dense, crack-free parts can be successfully printed. The results are further verified by micro computed tomography, showing that cracking can be arrested in the support before propagating through the parts. This method can be readily applied to other alloy systems without modifying the chemistry.

In this disclosure a systematic crack mitigation strategy through printing optimization is described for a custom high-strength Al alloy Al₉₂Ti₂Fe₂Co₂Ni₂ with nanoscale intermetallics fabricated by LPBF. The effects of primary processing parameters (laser power and scanning speed), as well as less concerned, secondary variables like strip length and contours were investigated. Based on our initial findings, it was concluded that cracking may not result from either composition-induced long solidification range or liquation. Instead, cracking is associated with the pronounced residual stress. By designing a scaffold support structure that deliberately favors cracking to release residual stress, fully dense, crack-free samples could be successively printed. Our work may broaden the arsenal to address the important problem of hot cracking issue and foster a better understanding of hot cracking mechanisms in high-strength Al alloy.

The experiments and results leading to this disclosure are presented below.

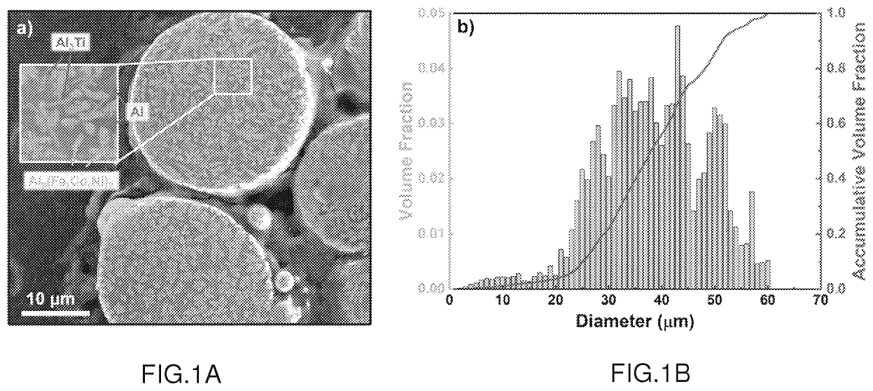

Sample fabrication: Spherical alloy powders with particle size of −53+15 μm and an atomic composition of Al₉₂Ti₂Fe₂Co₂Ni₂ were gas atomized by Atlantic Equipment Engineering, Inc. The Back-scattered electron (BSE) micrograph for the cross sections of the powder reveals two micron-sized intermetallic compounds, acicular Al₃Ti and globular Al₉(Fe,Co,Ni)₂, intermingled with dark Al matrix. Phases are determined by EDS and XRD profiles. Powder size distribution was constructed from analysis of 2,000 particles Most powder diameters range from 15 to 53 μm, while some small particles (below 15 μm) exist either adhering to the large powder or on their own. FIG. 1A shows cross-section morphology of the gas atomized Al₉₂Ti₂Fe₂Co₂Ni₂ alloy powders. The insert shows two forms of intermetallic compounds, acicular-Al₃Ti and globular-Al₉(Fe,Co,Ni)₂ in Al matrix. FIG. 1B shows particle size distribution of Al₉₂Ti₂Fe₂Co₂Ni₂ powders.

LPBF was performed in SLM 125 HL with an infrared 400 W IPG laser operating at 1,070 nm to print cuboid specimens with dimensions 10×10×5 mm (width×length×height). The printing process controls Al build plate temperature at 200° C. and chamber oxygen content below 0.1% after initial ultra-high-purity Ar flushing. By default, each layer is composed of parallel laser tracks segmented into short laser strips. Layer thickness, hatch spacing, layer rotation, laser strip length (SL) were kept constant as 30 μm, 100 μm, 67°, 1 mm, respectively, unless otherwise stated, while laser power and scanning speed varied. Laser defocus (DF) denoted the perpendicular shift of focal point to the powder surface and was assigned as 0 by default. Positive DF value indicates that laser focal point is higher than powder surface. Effective beam spot expands from 66 μm for the focal plane to 84 μm, 123 μm for ±2 mm, ±4 mm DF, respectively. Contours (borders) are additional tracks surrounding the outer surface and were set with two layers and 100 μm interspace. The chessboard pattern (island) was also utilized for some trials. The hatch space is 100 μm, consistent with the strip pattern and each patch (island) is 2×2 mm. Printed samples were sectioned off the plate by wire electrical discharge machining with a Mitsubishi FX-20K machine. Vickers hardness testing was carried out with a load of 100 gf and a holding time of 10 seconds. Physical values were averaged from 20 measurements for each parameter set.

To probe the processing window, frequently considered parameters include laser power (P), scanning speed (v), hatch space (h) and layer thickness (t). A derivative variable, volumetric energy density (VED), integrates these four parameters into one single formular (1) and estimates energy input for a given unit volume.

$$VED = \frac{P}{v \cdot h \cdot t} \qquad ( 1 )$$

Microscopy analysis: Optical microscopy (OM) and scanning electron microscopy (SEM) images were collected on an Olympus SZX7 and a Thermo Fisher Quanta Field Emission Gun (FEG) 650 microscope. All the samples were ground with SiC abrasive papers down to P-4000 grade, and polished with 1 μm diamond paste before microscopy study. The total removal was at least 300 μm of material on each surface of interest. BSE detector and secondary electron (SE) detector were utilized for probing the z-contrast microstructure and fractography.

Crack density is defined as ρ=total crack length V surface area (m/m2). Crack density statistics were measured in a semi-automated workflow containing extensions in the Fiji (Fiji is just ImageJ) software based on OM image inputs. OM images were binarized using a greyscale threshold to isolate the crack network. Pixels in the network were dilated several times to connect cracks separated by thresholding. The “skeletonize (2D/3D)” extension was used to generate the crack network and then the “Ridge Detection” extension broke down the network into measurable line segments (FIG. S3c). A line segment analysis tool was used to sum the segment lengths above 0.1 mm to exclude confusion with porosity contrast. This semi-automated method minimized manual measurement error.

Residual stress measurement: X-ray diffraction (XRD) measurements were conducted on a PANalytical Empyrean X′pert PRO MRD diffractometer with a 2×Ge (220) hybrid monochromator to select Cu Kα1 in the 2θ-ω geometrical configuration. Residual stress was derived from the peak shift using the sin² χ-D method in the laser track transversal and longitudinal directions on the bottom surface of the cuboid sample. χ denotes the tilt angle for the normal vector of the measured surface relative to the goniometer circle plane, and D denotes crystallographic planar spacing. Al (311) was selected because peaks with higher Bragg angle are more sensitive in response to residual stress, and the Al (311) peak does not overlap with precipitate peaks in this alloy. Peak positions were measured for χ=0°, 18.44°, 26.57°, 33.21°. The residual stress could be calculated by the following equation (2),

$${σ}_{r e s i d u a l} = ( \frac{\partial D}{\partial ( {sin}^{2} χ )} ) {( \frac{E}{1 + v} )}_{( 311 )} ( \frac{1}{{D}_{( 311 )}} ) \qquad ( 2 )$$

where elastic modulus normal to Al (311) planes E₍₃₁₁₎=72 GPa, Poisson's ratio v=0.33, Al (311) interplanar spacing D₍₃₁₁₎=1.2210 Å.

X-ray microscopy: X-ray microscopy (XRM) was conducted with a Zeiss Versa 620 lab-scale x-ray tomography system to examine cracks and porosity in three dimensions. Samples of interest were ground to a square cross section of 20.25 mm² orthogonal to the plane of the baseplate. Samples were then scanned with the cross section's normal plane oriented vertically. Scans were conducted with the samples 14 mm from the x-ray source and 12 mm from a detector with 4× optical magnification, giving a final voxel size of 3.65 μm. To capture the full sample volume, a wide view scan strategy was applied, whereby the sample axis was shifted and rotated to produce two scans with extended field of view, which were then stitched automatically by the system's built-in software. Additionally, the top and bottom halves of the samples were scanned separately then stitched using tomography system software. As a result, the field of view was extended to 450×450× 484 μm.

Filtering of the 3D tomography data was done in Avizo 9 (Thermo Fisher Scientific). A median smoothing filter was first applied to reduce noise, followed by a nonlocal means smoothing filter to produce distinct grey values for voids and the alloy. Last, an unsharp mask filter was applied to highlight edges, resulting in minimized noise and sharp edges between the metallic matrix and defects. Segmentation was then performed manually to separate the alloy matrix, cracks, and pores into distinct label groups. A greyscale threshold was used to identify the matrix, and pores were segmented based on size. Thin cracks and pores contacting cracks were segmented using a brush tool. Measurements of the segmented features were performed as voxel counts of connected volumes.

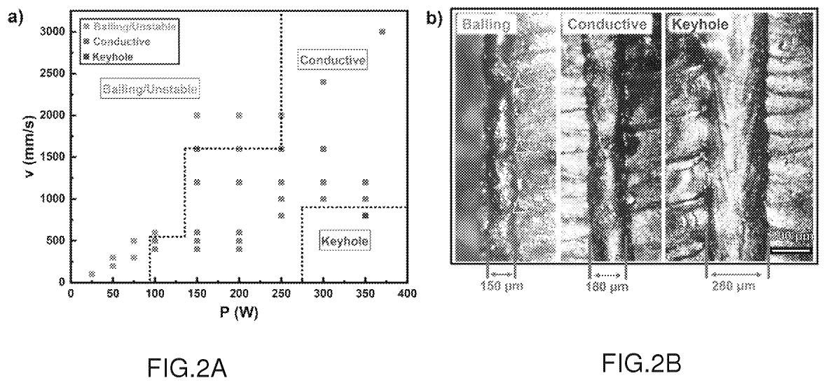

Single track observations: Single laser track experiments were conducted as a common practice to probe the processing window prior to actual printing the customized Al₉₂Ti₂Fe₂Co₂Ni₂ alloy. Large variations of laser power (ranging from 25 to 370 W) and scanning speed (ranging from 100 to 3000 mm/s) were explored for a thorough understanding of the melt pool behaviors. Three regions were determined in FIG. 2A 1) a balling region, characteristic of unstable fluid dynamics and resultant discontinuous melt beads, 2) a conductive region with tracks of consistent width and stable fluid dynamics, and 3) a keyhole region, overheated by high energy input, leading to broad tracks with cavities beneath the surface as confirmed by cross section SEM (not shown in the paper). It is also found that the melt pool expands both horizontally and perpendicularly as VED escalates, increasing the aspect ratio (depth/width). It's worth mentioning that all laser tracks do not exhibit any cracks under SEM. Subsequent printing experiments aimed primarily at the conductive region with reasonable VEDs as well as some marginal balling and keyhole region. FIG. 2B shows top-down views showing the morphologies and widths of the representative laser tracks for each region of FIG. 2A (Balling: 250 W, 2000 mm/s; Conduction: 250 W, 1200 mm/s; Keyhole: 350 W, 800 mm/s. The arrows indicate the discontinuous beads which do not form as a regular track.)

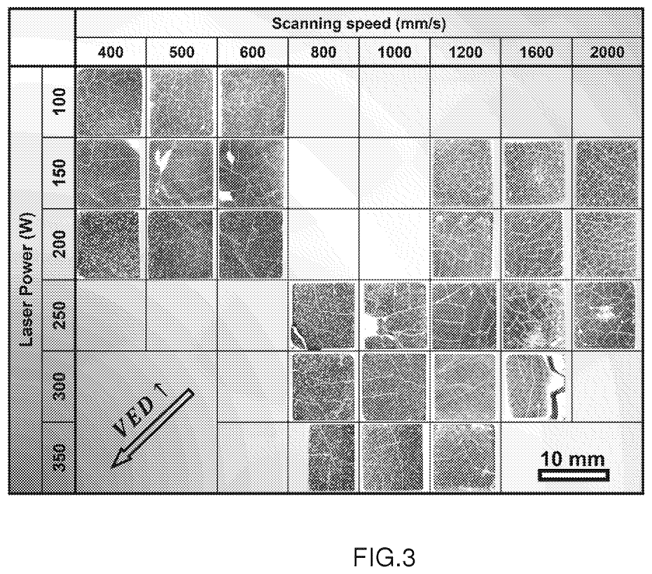

Impacts of primary parameters: Extensive optical microscopy images were collected for the specimens printed with the default strategy for a wide range of laser power and scanning speed (FIG. 3). FIG. 3 shows a panoramic view of optical microscopy images for the bottom surface of samples printed with various laser power and scanning speed. The lower left corner represents a high volumetric energy density (VED).

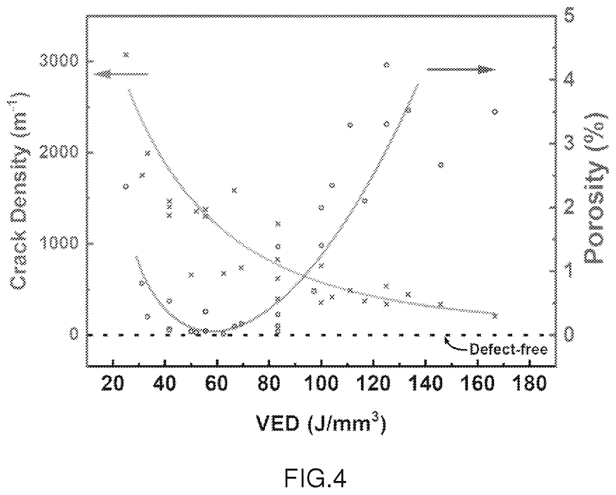

Two major classes of defects, solidification cracks (white lines) and pores (white speckles), were identified from the optical images. Cracks formed as an inter-connected network terminated on the side surfaces. No significant orientation dependence was observed for cracks. The relevant statistics were performed using the computer-aided method (FIG. 4). FIG. 4 shows statistics on evolution of porosity and crack density with VED. Crack density monotonically decreases with increasing VED, but cracks cannot be fully eliminated within the investigated range. Porosity reaches a valley at around 60 J/mm³. A clear trend of defect populations was observed with respect to VED. As VED increased from 20 to 170 J/mm³, i.e., higher laser power or lower scanning speed, crack density consistently decreased from 3000 to 250 m⁻¹. No parameter set within the investigated scope was capable of producing crack-free samples. In comparison, porosity reached a minimum, being nearly porosity free at intermediate VEDs (around 60 J/mm³) and then rose to 4% at high VEDs. Lack-of-fusion pores with an irregular shape dominate at low VEDs whereas nearly spherical keyholes appeared at high VEDs. As such, VED could not be increased to reduce cracking further without introducing destructive quantities of keyhole pores. Routine parameter optimization on laser power and scanning speed could not yield fully dense and crack-free samples fulfilling structural applications.

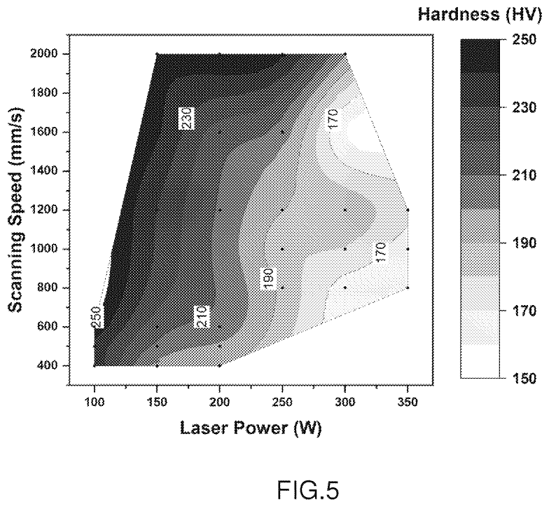

Vickers hardness measurements in FIG. 5 demonstrate the high hardness of this alloy, ranging from 160 to 250 HV. The hardness is generally inversely related to VED and seems to be more dependent on laser power rather than the scanning speed. Samples printed with varying VEDs appear to have very close phase constituents.

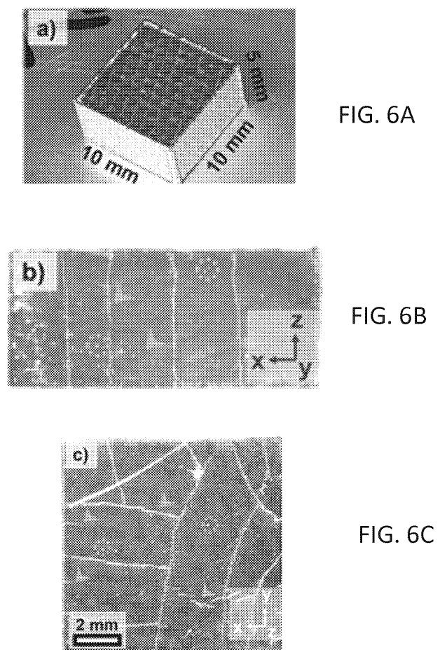

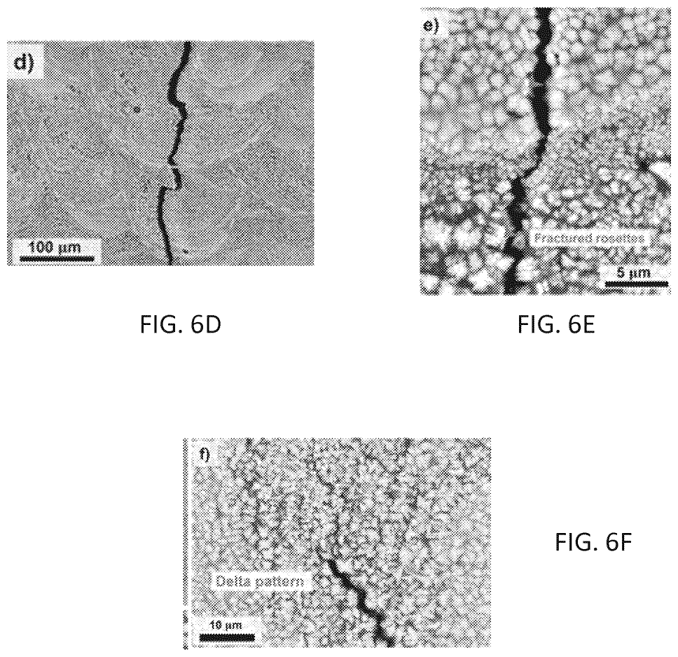

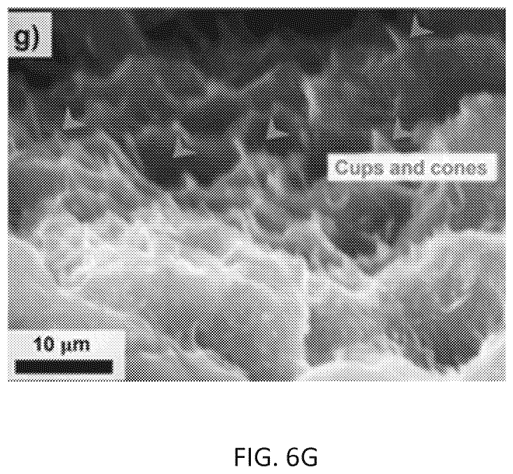

FIGS. 6A through 6F presents images and micrographs of the specimen (10×10×5 mm) printed with adequate laser power based on the porosity curve (P=250 W, v=1200 m/s, VED=69 J/mm³). The integrity of geometry was maintained despite minute warping and peeling-off on the bottom. Cracks and pores are highlighted on the optical microscopy images (FIGS. 6B and 6C). It could be seen from the side surface that most cracks are major and propagated to the top surface, whereas occasionally there are some minor cracks terminated in the interior. On the bottom surface, minor cracks appear near the contour region and get terminated. Cross-sectional SEM images (FIGS. 6D and 6E) reveal a heterogeneous microstructure, containing lamellar intermetallic colonies (white contrast) of Al₉(Fe,Co,Ni)₂ and Al₃Ti in Al matrix (grey contrast). The chemistry and mechanical behaviors of these intermetallics precipitates are discussed elsewhere. Primary cracks penetrated multiple weld tracks with melt pool boundaries denoted in pink. Along the pathway of cracks, some intermetallic rosettes cracked internally, while most intermetallic rosettes deflected cracks into the Al matrix. In images of a crack tip taken on the xy plane (FIG. 6F), a broad crack is split into several insignificant vanishing microcracks, resembling a river delta. A top-down view of the crack surface in FIG. 6 G shows a rough, irregular texture with “Cups and cones” morphology.

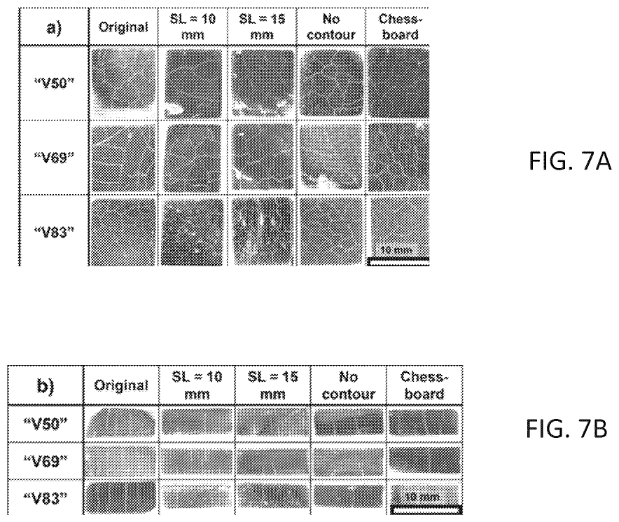

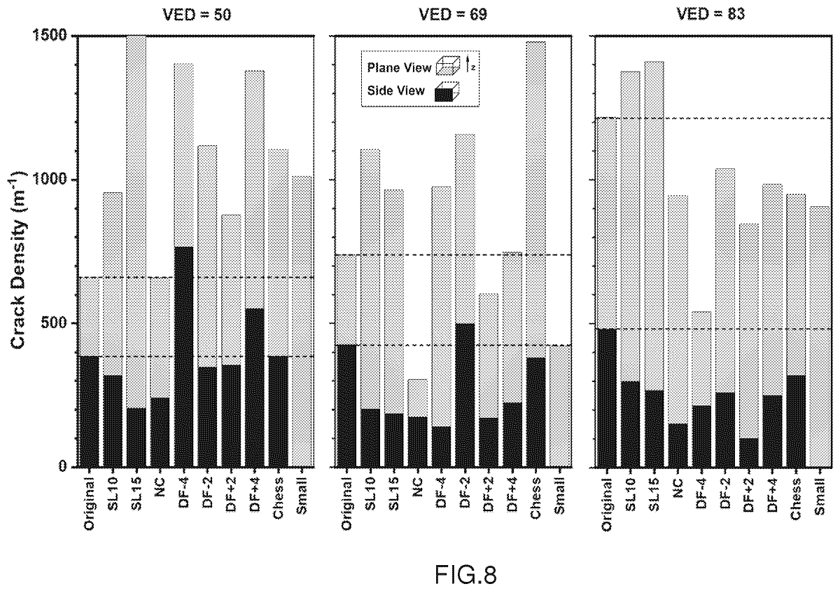

Impacts of the secondary parameters: Given undesirable quantities of either cracking or porosity after attempting to optimize laser power and scanning speed, the effects of other processing parameters on crack mitigation were investigated to mitigate cracking. These parameters included scanning strip length (SL), contours (vs no contours), defocus length of laser (DF), scanning pattern, and dimensions of samples. Three VEDs were selected from the low porosity VED range in FIG. 4. These represent three scenarios: slightly underheated “V50” (P=300 W, v=2000 mm/s, VED=50 J/mm³), intermediate “V69” (P=250 W, v=1200 mm/s, VED=69 J/mm³), and slightly overheated “V83” (P=100 W, v=400 mm/s, VED=100 J/mm³) in reference to the VED with minimal porosity around 60 J/mm³. Specimens were fabricated by varying the default parameters one at a time to study individual parameters' effects. Optical micrographs were collected for plan-view and cross-section of the specimens as shown in FIG. 7. The measured crack densities are then presented for the cross-section and side views in FIG. 8, with horizontal lines drawn to show the crack densities measured for default parameters. The complex effects of these various parameter result in both positive and negative changes in crack density.

SL is set to 1 mm by default and was varied to 10 mm and 15 mm. In the 1 mm situation, the laser repeatedly activates, writes short strips, diminishes, and re-activates across a single track. Given a scan strategy rotated with respect to the cube edges, the longest cube dimension is the corner-to-corner diagonal, which is 14.4 mm. Thus, a 15 mm strip length is required to scan from end to end in a single scan track. A 10 mm strip length is intermediate. For the three VED settings, crack density decreases on the side surface with longer strip lengths but increases on the bottom surface.

FIG. 8 shows statistics of crack density in specimens fabricated with the three selected VEDs and varying secondary parameters in FIGS. 7A and 7B. As for contours, removing contours for three VEDs is beneficial in cutting down crack density on both planes, especially for V69 (FIG. 8 VED=69 J/mm³), which gives minimal crack density among all the trials.

Laser defocus length varied from 0 to ±2 mm and ±4 mm and its effect on crack density seems to depend on VED. As for underheated “V50” (FIG. 8 VED=50 J/mm³), all four defocus distances produced a higher crack density compared with the default one. Focal plane shifts exacerbated cracking on both surfaces, and larger shifts led to worse cracking. The effects of opposite signs of DFs are symmetrical given the same values. However, as for overheating “V83” (FIG. 8 VED=83 J/mm³), all DF distances reduced cracking. Crack density changed inconsistently with varied DF settings, however. Mixed effects of DF on cracking were observed for “V69” (FIG. 8 VED=69 J/mm³).

Another parameter considered was scanning pattern. The influences of two common patterns, chessboard and strips, on crack density are tested. Crack density decreased for “V50” and “V69” but increased for “V83” using when a chessboard pattern was used. Besides, small samples printed with dimensions 6×6×3 mm showed increased cracking for “V50” but decreased cracking for “V69” and “V83” (FIG. S6). Thus, secondary parameters could greatly influence the crack populations, and the modification of certain parameters will reduce cracks; but cannot completely eliminate cracking.

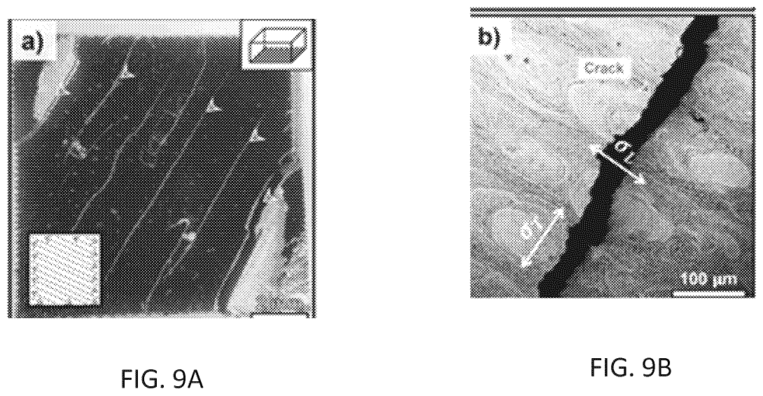

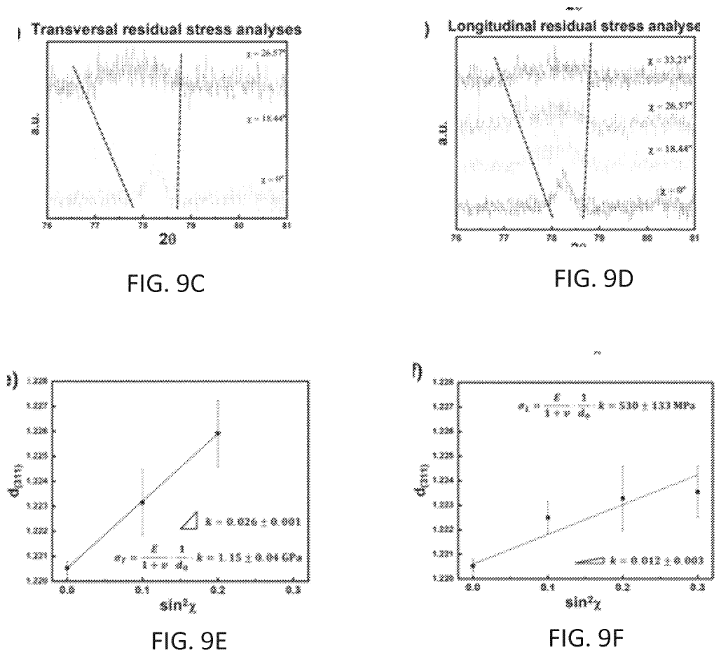

Residual stress analysis: To resolve the mechanism of solidification cracking, one specimen “V69” following the default print strategy is printed but with no layer rotation, no contour, and 15 mm SL. The polished bottom surface was imaged and is shown alongside the bi-directional scanning strip vectors in FIG. 9A. It is intriguing that most cracks denoted arrows extend orthogonally to the laser scanning direction. An SEM micrograph (FIG. 9B) confirms that cracks opened through laser weld tracks in the longitudinal direction. X-ray analyses characterized the normal residual stress in both transversal and longitudinal directions (FIGS. 9C through 9F)). Significant tensile residual normal stress is present in both directions and value can be around 1 GPa and 500 MPa in transversal σ_T and longitudinal σ_L directions, respectively.

Scaffold structure: Inspired by the alleviated residual stress as a consequence of crack generation, a compartmentalized support structure was designed to relax residual stress by intentionally favoring distortion or even cracking formation. Three representative support variants were designed for this purpose. A design successfully survived printing and produced parts.

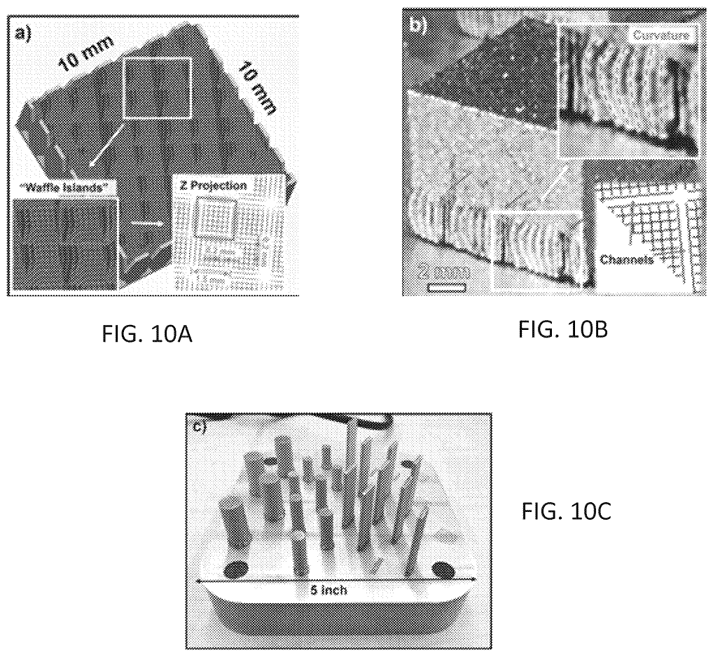

A scheme is shown in FIG. 10A to demonstrate the detailed structure of this scaffold support. The support is comprised of multiple duplicated 1.5×1.5 mm cells, and each cell is composed of intersecting vertical thin platelets with 0.2 mm interspace, which mimic the hatched walls of a waffle. In contrast to the hatch space of 0.1 mm producing solid parts, this doubled hatch space of 0.2 mm intentionally builds cavity arrays into the support structure. Each platelet is 1.5 mm wide and chamfered on the four corners. Between every neighboring two “waffle” cells, there are run-through channels with a width of 0.2 mm. Cuboidal specimens were printed on top of these “waffle islands.” Optical images in FIG. 10B show that prominent distortion is present in the “waffle islands”, which are designed to be straight and perpendicular. A closer view in the insert reveals that curvature (denoted with red dashed lines) for platelets seems to escalate inside each cell, reset, and iterate this pattern among cells. Cavities (black vertical lines) where inter-cellular channels intersect the side surface are also misshaped. Some delamination happens to the bottom joint interface. Beyond cuboidal samples, crack-free cylindrical bars and vertical slabs were successfully printed with the support structure without visible surface cracking (FIG. 10C).

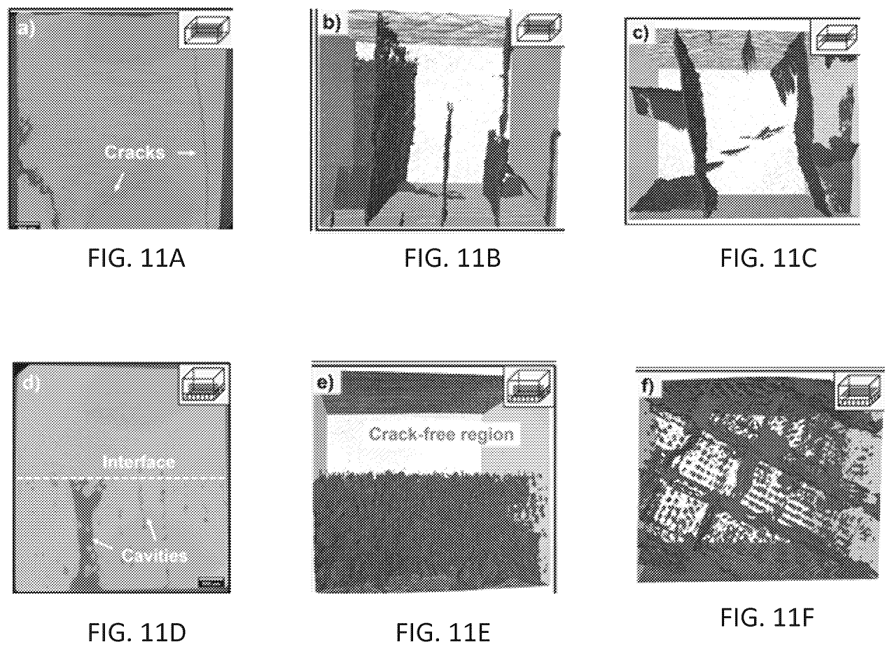

Scaffold imaging: Side surfaces of cuboidal samples on support structure were polished, and no visible cracks were found under SEM. However, internal cracks may occur and still jeopardize the mechanical performances. Two samples of the same laser power 250 W and scanning speed 1200 mm/s (V69) were printed with and without the support structure (denoted “support” and “control”, respectively). Internal voids in these two samples were studied with x-ray microscopy in FIG. 11A through 11F. From the cross-section views and backward-forward rendering views, the control sample contains multiple large vertical cracks, and some cracks extend to the top surface (FIGS. 11A and 11B), which is consistent with the optical microscopic observations. However, the support sample only exhibits cavities below the scaffold, and no cracks are found in the actual part (FIGS. 11D and 11E). Bottom-up projections confirm cracking in the control sample (FIG. 11C). FIG. 11F shows the designed “waffle islands” structure is properly rendered in the support sample. Small pores are left between vertical platelets inside cells, while large cavities form at the intersections of inter-cellular channels. Channels connecting large cavities seem to be highly deformed and tortuous, which verifies the compliance of the support structure. Support is not only preferred for crack elimination, but also for densification. Porosity dropped from 0.19% for the control sample to less than 0.1% for the support sample. Pore diameter follows a lognormal distribution for both samples, and the mean pore diameter shrank from 11.9 μm for the control sample to 6.6 μm for the support sample.

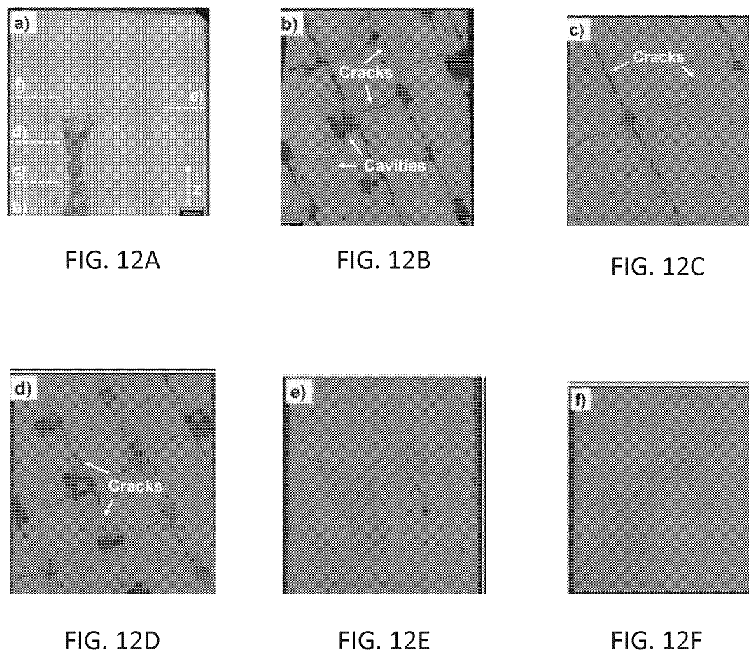

To examine how the compliant support structure interacts with the cracking, horizontal cross sections at different heights are presented in FIGS. 12A through 12F. In general, cracks fade away rapidly with a reduction in both gap width and density, as the height increases. In the vicinity of the bottom surface (in contact with build plate), cracks are large and generally follow the perpendicular orientations of the inter-cell channels. Cracks are fairly tortuous, and some propagate into cells and connect to small pores (FIG. 12 B). At the height of 1 mm, cracks inside cells seem to disappear and channel crack density diminishes as well (FIG. 12C). Intra-cellular channels are visible as powder-filled voids. Higher in the scaffold, channel cracks almost vanish, too (FIG. 12 D. Near the top of the scaffold, it becomes difficult to distinguish cracks among the inter-cellular channels, and the centers of the “waffle islands” become fully dense (FIG. 12E). When it approaches the sample interior, cracks are fully eliminated (FIG. 12F).

The effects of printing parameters on crack mitigation: Processing window assessment of this custom Al alloy began with single laser track experiments for high efficiency screening, a strategy that has been demonstrated previously. The main purpose of the single laser track studies is to exclude any unstable or defective tracks to prevent defect accumulation. Cube specimens printed with relatively low and high VEDs will manifest lack-of-fusion pores and near-spherical keyholes inherited from the single tracks, respectively, which are reflected in the high porosity at two VED extremities (FIG. 4). An increase in the melt track aspect ratio (Depth/Width) also corroborates the transition of melt pool dynamics from the conduction mode to the keyhole mode as VED increases. Conduction melting is preferred, though slight shifts toward keyhole mode are found to reduce crack sensitivity. However, printing reliability is not fully guaranteed by proper parameter sets evaluated by single laser track morphology due to track interplay. The overlap region between adjacent tracks could undergo multiple stages of annealing, partial melting, and full remelting. A thermal history which includes multiple temperature spikes, in contrast to the single spike of a single track, may give rise to the cracking observed in most of the samples shown in FIG. 3. In spite of the prevailing cracks, higher VED (higher laser power or lower scanning speed) would reduce crack density, due to attenuated thermal shock, longer duration for liquid backfill and reduced residual stress. It is interesting to notice this crack alleviation phenomenon by higher VED is different from what has been reported in AM AA 7075 and AA 2024 alloys, implying the existence of an alternative cracking mechanism. A proper range of VED, ~60 J/mm³, is identified for providing minimal porosity (FIG. 4). However, in such conditions, there is still cracking, as crack density decreased monotonically with increasing VED. It is evident from FIG. 4 that tailoring VED alone is insufficient to remove porosity and cracks simultaneously to achieve near full density.

The effects of other printing parameters (strip length, contour, and defocus) on crack density are revealed from the qualitative and quantitative views of numerous samples in FIG. 7, and FIG. 8. Strip length shows anisotropic impacts on crack density on the xy and yz planes. Compared to the samples printed using a strip length of 1 mm, increasing the strip length to 10 or 15 mm decreases crack density on the yz plane but increases crack density on the xy plane. The reduced crack density on the yz plane is manifested from shorter crack propagation paths. A likely explanation would be that less frequent pauses and reheating by using longer strip lengths would impose fewer recurring thermal shocks and could lead to reduced cracking, as witnessed on the yz plane. Though the crack density surges on the xy plane, smaller crack gap separations are indicated by less defined and faint cracks. The contour strategy is commonly used for better surface finishing, as the perimeters of a part are printed first to achieve a rigid and well-defined surface, followed by the fill of the built interior. The removal of contours (NC) has a beneficial effect in crack mitigation as observed in all VEDs (FIG. 7), and the NC strategy is more prominent in the “V69” group. Contours seem to trigger cracking from the periphery where contours join with interior laser tracks and deteriorate printability (as shown in FIG. 6 section c, which was printed with contours). It is postulated that cracking may partially result from the inability for stress relaxation due to structural confinement imposed by contours. For this custom Al alloy, densification could be partially improved by fine tuning defocus for certain groups of specimens, such as “V69” (FIG. 8) and “V83” (FIG. 8). However, the effect of defocus on crack reduction in the “V50” group (FIG. 8) is inconclusive. Defocus redistributes the laser energy flux and could change the melting modes. Keyhole melting with a tapered melt pool morphology could be obtained by a negative defocus distance, which enhances crack resistance evidenced by previous reports. Chessboard scanning pattern and smaller dimensions seem to have an ambiguous effect on cracking.

The mechanisms of hot cracking: Hot cracking in aluminum is generally considered as an interplay of several factors, such as constitutional liquation, dendritic growth and residual stress. Various mechanisms were proposed to account for hot cracking, including the prevailing solidification cracking and liquation cracking mechanisms in Al alloys. These two mechanisms may not be mutually exclusive, as initiation of one could foster the occurrence of the other mechanism. In what follows, we will show that the cracking mechanism present in this Al₉₂Ti₂Fe₂Co₂Ni₂ alloy appears different from prior studies. First, micron-size “cups and cones” morphology (FIG. 6 section g) implies that fracture happens in the solid state while both solidification cracking and liquation cracking necessitate the existence of thin liquid films. The ductile Al matrix is expected to deform while rigid intermetallic rosettes accommodate less strain. Fracture comes into rise after plastic Al dimples and disunites. These pointed, cellular flakes entail plasticity carried by dislocation motions in crystalline solids. However, liquation features either globular and dendritic surfaces in solidification cracking, or smooth and flat surfaces in liquation cracking, because cracking happens in the semi-solid state and liquid surface tension will prevent any singularity on the crack surface, as reported in AA2024, AA7075 and Al—Cu. Additionally, liquidous cracks are typically manifested on the longitudinal centerline for solidification cracking or partially melted zone for liquation cracking. These fractographic traits differ from the predominant transversal cracking observed in this alloy.

Second, liquation is characteristic of micro-segregation of soluble elements near grain boundaries, like Mg, Cu, Zn. The concentration of low-melting-point elements enlarges the solidification temperature range at the final stage. But in the case of Al₉₂Ti₂Fe₂Co₂Ni₂ alloy, these transition metals form precipitates readily in the beginning and have limited solubility in Al at the eutectic point. Therefore, the limited amount and lifespan of liquidous films have minimal impact on cracking. In theory, the liquid backfill model to predict liquidation susceptibility. The flat end of the Al₉₂Ti₂Fe₂Co₂Ni₂ solidification curve has a lower slope, (dT/d(\sqrt{fₛ})<100 K, than the AA7075 (4579 K) and AlSi10Mg curves (645 K), which indicates lower cracking susceptibility. In fact, this criterion empirically considers the range where the solid fraction fₛ is near a critical value around 1.0, as liquid backfill is most challenging at the final stage due to the considerable obstruction from the developed dendrites and the least amount of liquid. Thus, the slope (1111K) derived conservatively from the broad range for this alloy may exaggerate the physical cracking susceptibility. Additional crack resistance could come from the nucleants breaking down columnar grains into equiaxed grains that better accommodate solidification strain. Despite a low predicted cracking susceptibility based on the Scheil-Gulliver model, this alloy is still subject to severe cracking as described earlier.

Solid state cracking mechanisms that are less frequently considered in AM Al alloys include ductility dip cracking and strain-age cracking (reheat cracking). Ductility dip cracking refers to intergranular tearing in an intermediate temperature range where a material's ductility reaches a minimum. Strain-age cracking occurs when precipitation induces residual stress during post-weld heat treatment. Both terms are frequently discussed in the context of Ni-based superalloys or steels. These concepts may have insignificant effect on understanding cracking observed in the current custom-designed Al alloy.

Despite the elusive underlying mechanisms, it can be concluded from multiple observations that hot cracking is governed by residual stress for the customized Al₉₂Ti₂Fe₂Co₂Ni₂ alloy. First, the direct evidence comes from the significant tensile residual stress on the bottom interface in both directions (FIGS. 9E and 9F). The magnitudes of tensile stress (0.5-1 GPa) may be somewhat exaggerated, but large tensile stress could tear apart specimens to release local stress concentrations. More frequent cracking normal to the longitudinal direction was observed, consistent with a lower σ_{L}, whereas a considerably larger σ_{T} in the transverse direction is retained without relaxation. In addition, the radial crack network resembling the delta at the crack tip (FIG. 6F) suggests residual stress relaxation can stop crack propagation, confirming the primary role of residual stress on cracking.

Second, single laser tracks experiments with various printing parameters are not subject to any cracking issue, in contrast to cracking in the bulk parts (containing aggregates of laser tracks). This observation suggests that the development of cracking requires interactions of laser tracks and accumulation of residual stresses. It is well accepted that residual stress can accumulate from repeated thermal cycles during AM. An over-simplified model states that during solidification of a single laser track, a fusion zone starts to consolidate and contract under the restraint of the surrounding materials, which would impose a tensile residual stress on the scanned region and a compressive residual stress near the heat affected zone. For a general AM process that involves the printing of multiple layers, the established residual stress on the previous layer would be compensated, neutralized, or exacerbated by newly developed residual stress on the succeeding layer, and thus the evolution of residual stresses depends on the consolidation chronology and strategies. These interactions complicate the residual stress distribution and even lead to contradictory parametric effects on stress evolution. In the case of AlSi10Mg, a tensile residual stress appears on the bottom and a compressive stress on the top as measured by the hole drilling strain gauge method, whereas in the case of 316L stainless steel, an outer hull with tensile stress and a core with compressive stress was found utilizing neutron diffraction. In spite of the divergence of residual stress evolution in AM metallic materials, both scenarios indicate that a tensile residual stress could couple with vulnerable defects to foster the upward crack propagation as shown from the side view of AM Al alloys (FIG. 6 B).

Additionally, the observed crack healing effect driven by higher VEDs, contrary to literature reports, can be attributed to residual stress relaxation mechanism. A broader fusion zone resulting from increased energy input facilitates dislocation activities, extending the plastic deformability of alloys. This improved plasticity is favorable for residual stress relaxation, resembling effects of a higher substrate temperature on crack mitigation.

The effects of support structure: Support structures are typically designed to support overhanging planes or facilitate sample removability from the build plate. Here we adapted support structures for stress relief. The crack elimination effect of a support structure is validated for this custom high-strength Al₉₂Ti₂Fe₂Co₂Ni₂ alloy. Literature reports also find support could improve the relative density of materials in some cases. As is observed from the distorted islands, the support structure enables flexibility and serves as a buffering layer between the rigid build plate and actual parts. It is believed that the crack mitigation effect stems primarily from this sacrificial compliance accomplished by this lattice design. Cracks are deliberately provoked in the support in a controllable fashion and residual stress gradually fades out. The support cushions the build parts of interest under cyclic thermal loading due to thermal shocks. Additionally, cavities could alleviate cracking by accommodating volume shrinkage and contraction during solidification. It is worth mentioning that our support structure differs from the common context in that our support structure has adjacent platelets that are partially merged as a consequence of a small spacing of 0.2 mm apart, instead of being further separated, like 0.9 mm in this case. This small spacing which results in a compacting support seems to be critical, since a larger spacing, like 0.4 mm, led to warpage and eventually failure. Inter-platelet cavities are distributed in a speckled manner, which could uniformly lessen geometric variance during solidification. Another effect of these open arrays in the support structure is to toughen the support material by rounding crack tips. When intersecting with cracks, globular pores with smaller curvature can sustain high residual stress compared to sharp crack tips. Thus, pores could serve as crack sinks, and an improved cracking resistance is anticipated. In addition, supports lift parts above the surface on the build plate, where the printability is deteriorated by an abrupt change of cross section area for thermal exchange, fusion and diffusion in dissimilar materials joints across the interface. Beneficial to release residual stress, a higher temperature than the build plate temperature could be achieved by the bottlenecked heat dissipation through the open support structure, as unsintered powders and cavities between support platelets retard heat conduction. However, more importance should be attached to compliance and crack sinks, because other support designs with less heat exchange area and more prominent heat retention, failed printing due to the significant warpage induced by the residual stress.

As mentioned before, hot cracking has been widely observed in high-strength Al alloys during additive manufacturing. Based on the above detailed description, it is clear that this disclosure presents numerous strategies that deal with hot cracking in a custom-designed high-strength Al₉₂Ti₂Fe₂Co₂Ni₂ alloy produced by LPBF. Printing parameter optimization on laser power and scanning speed found that a compromise had to be made between cracking and porosity. Further tuning of other AM parameters (defocus, contours, laser strip length, and scan strategy) demonstrates that cracking can be mitigated but not fully eliminated. More significantly, it was found that the incorporation of a compliant support structure successfully eliminated all cracks as confirmed by micro-CT analyses. XRD analyses, fractography, and solidification history suggest that cracking is attributed to solid state tearing under substantial tensile residual stresses. The support structure releases residual stress and cushions the parts of interest under cyclic thermal impacts, thus eliminating cracks effectively. Based on this disclosure proper design of support structures has widespread applications to improve printability of various hard-to-print metallic materials that suffer from residual stresses.

Based on the above detailed description it is an objective of this disclosure to describe a method of mitigating crack formation in an article produced by additive manufacturing process utilizing selective laser melting (SLM). The method contains the steps of 1) utilizing a selective leaser melting (SLM) apparatus to produce a first layer of particles of a selected material on a substrate and melting and solidifying a first group of selected areas of the first layer of particles, wherein the melting and the solidification results in a pre-determined structure of the selected material, 2) repeating utilization of SLM apparatus to produce second and subsequent layers as needed to produce layers of desired configurations to result in a predetermined scaffolding structure; and 3) utilizing a selective leaser melting (SLM) apparatus to produce an article of specified thickness and shape on top of and in contact with the scaffolding structure. In some embodiments of the method of this disclosure, the selected material is an alloy of composition 92 at % aluminum, 2 at % titanium, 2 at % iron, 2 at % cobalt, and 2 at % nickel. In some embodiments of the method of this disclosure the article of specified thickness and shape on top of and in contact with the scaffolding structure is free of cracks larger than 1 micrometer in any given dimension.

It is another objective of this disclosure to describe an article produced by the method of claim 1. In some embodiment of the article, the selected material is an alloy of composition 92 at % aluminum, 2 at % titanium, 2 at % iron, 2 at % cobalt, and 2 at % nickel. Ins some embodiments of the article, the article of specified thickness and shape on top of and in contact with the scaffolding structure is free of cracks larger than 1 micrometer in any given dimension.

While the present disclosure has been described with reference to certain embodiments, it will be apparent to those of ordinary skill in the art that other embodiments and implementations are possible that are within the scope of the present disclosure without departing from the spirit and scope of the present disclosure. Thus, the implementations should not be limited to the particular limitations described. Other implementations may be possible. It is therefore intended that the foregoing detailed description be regarded as illustrative rather than limiting. Thus, this disclosure is limited only by the following claims.

1. A method of mitigating crack formation in an article produced by additive manufacturing process utilizing selective laser melting (SLM), the method comprising:
utilizing a selective leaser melting (SLM) apparatus to produce a first layer of particles of a selected material on a substrate and melting and solidifying a first group of selected areas of the first layer of particles, wherein the melting and the solidification results in a pre-determined structure of the selected material.
repeating utilization of SLM apparatus to produce second and subsequent layers as needed to produce layers of desired configurations to result in a predetermined scaffolding structure; and
utilizing a selective leaser melting (SLM) apparatus to produce an article of specified thickness and shape on top of and in contact with the scaffolding structure.

2. The method of claim 1, wherein the selected material is an alloy of composition 92 at % aluminum, 2 at % titanium, 2 at % iron, 2 at % cobalt, and 2 at % nickel.

3. The method of claim 1, wherein the article of specified thickness and shape on top of and in contact with the scaffolding structure is free of cracks larger than 1 micrometer in any given dimension.

4. An article produced by the method of claim 1.

5. The article of claim 4, wherein the selected material is an alloy of composition 92 at % aluminum, 2 at % titanium, 2 at % iron, 2 at % cobalt, and 2 at % nickel.

6. The article of claim 4, wherein the article of specified thickness and shape on top of and in contact with the scaffolding structure is free of cracks larger than 1 micrometer in any given dimension.
